(19) United States
(12) Patent Application Publication
(10) Pub. No.: US 2019/0047463 A1
(43) Pub. Date: Feb. 14, 2019

(54) SYSTEM AND METHOD FOR COMPREHENSIVE TRAILER DUNNAGE

(71) Applicant: Walmart Apollo, LLC, Bentonville, AR (US)

(72) Inventors: Andrew Rizkallah, Columbus, OH (US); Patricio A. Hudson, Fayetteville, AR (US); Nathan L. Bearden, Springdale, AR (US)

(73) Assignee: Walmart Apollo, LLC, Bentonville, AR (US)

(21) Appl. No.: 16/054,381

(22) Filed: Aug. 3, 2018

Related U.S. Application Data
(60) Provisional application No. 62/543,103, filed on Aug. 9, 2017.

(51) Int. Cl. B60P 7/06

(52) U.S. Cl. CPC B60P 7/065

(57) ABSTRACT

An airbag system for securing cargo in a container configured as disclosed herein can include: a support structure adapted to attach to a ceiling of the container; an array of airbags suspended from the support structure, each airbag being removeably detachable from the support structure; an air pressure system in fluid communication with each air bag of the array of airbags; and a control system adapted to control the air pressure system to inflate the array of airbags. In an inflated configuration, the array of airbags extends downward from the support structure toward a floor of the container until each airbag of the array of airbags contacts an upper surface of the cargo or the floor of the container.

### BACKGROUND

### 1. Technical Field

The present disclosure relates to cargo transportation, and more specifically to using inflatable bags to secure cargo during transportation.

### 2. Introduction

Distributors often use containers such as trailers to ship merchandise to retail stores, and retailers may use trailers to ship the merchandise to customers. The trailers transport packages of various sizes, and sometimes including both floor-loaded packages and pallet-loaded packages. It is imperative that the cargo does not sustain damage during transport, and arrives at its destination in the condition in which it was loaded onto the trailer. However, existing restraining systems are inadequate and cannot be adapted to secure different sizes and quantities of cargo. Therefore items can shift during transport, potentially damaging the cargo.

### SUMMARY

An airbag system for securing cargo in a container configured as disclosed herein can include: a support structure adapted to attach to a ceiling of the container; an array of airbags suspended from the support structure, each airbag being removeably detachable from the support structure; an air pressure system in fluid communication with each air bag of the array of airbags; and a control system adapted to control the air pressure system to inflate the array of airbags. In an inflated configuration, the array of airbags extends downward from the support structure toward a floor of the container until each airbag of the array of airbags contacts an upper surface of the cargo or the floor of the container.

A container for shipping cargo configured as disclosed herein can include: a support structure attached to a ceiling of the container; an array of airbags suspended from the support structure, each airbag being removeably detachable from the support structure; an air pressure system in fluid communication with each airbag of the array of airbags; and a control system adapted to control the air pressure system to inflate the array of airbags. In an inflated configuration, the array of airbags extends downward from the support structure toward a floor of the container until each airbag of the array of airbags contacts an upper surface of the cargo or a floor of the container.

A method for securing cargo in a container can include: securing an array of airbags to a ceiling of the container; and after the container has been loaded with cargo, inflating the array of airbags such that each airbag extends downward from the ceiling of the container and exerts a downward force on either the cargo or a floor of the container.

An airbag system for securing cargo in a container, the container being partially filled with pallet-loaded freight and floor-loaded freight, configured as disclosed herein can include: a support structure adapted to attach to a ceiling of the container; an array of airbags suspended from the support structure, each airbag being removeably detachable from the support structure; an air pressure system in fluid communication with each airbag of the array of airbags; and a control system adapted to control the air pressure system to inflate the array of airbags. In an inflated configuration, the array of airbags extends downward from the support structure toward a floor of the container until each airbag of the array of airbags contacts an upper surface of the pallet-loaded freight, the floor-loaded freight, or a floor of the container. The array of airbags contacts the upper surface of the pallet-loaded freight and the floor-loaded freight at a plurality of different heights. The array of airbags provides downward forces on the pallet-loaded freight and the floor-loaded freight that prevent the pallet-loaded freight and floor-loaded freight from becoming dislodged during transport of the cargo.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example of an airbag system for securing cargo in a container;

FIG. 2A illustrates an example of the airbag system of FIG. 1 in an inflated configuration.

FIG. 2B illustrates an example of the airbag system in which the airbags do not have a uniform size.

FIG. 3 illustrates an example of an airbag.

FIG. 4 illustrates an example of a container having an array of air bags in an inflated configuration, wherein each airbag extends to a different depth.

FIG. 5 illustrates an example in which two groups of cargo are separated by air bags that extend all the way down to the floor of the container.

FIG. 6 illustrates an example pneumatic system.

FIG. 7 illustrates a trailer loaded with cargo, wherein airbags in the rear portion of the trailer are maximally inflated to extend to the floor of the trailer.

### DETAILED DESCRIPTION

Containers such as semi-trailers, multi-modal containers, shipping containers, and the like are useful for transporting large volumes of merchandise from one location, such as a warehouse, to another location, such as a brick-and-mortar store. Ideally, each container used to transport cargo would be completely full, utilizing the container's cargo hold as efficiently as possible. Completely filling the inner cavity of the container has the additional advantage of providing stability. If the cargo is packed such the no space remains between the individual items, then the items cannot shift during transport, and therefore are less likely to sustain damage in transit.

However, it is often necessary to ship cargo without completely filling the container. For example, there may be a limited number of items that need to be sent to a particular destination, and the items may not be sufficient to fill the container. Alternatively, the items to be shipped may have shapes or sizes that may prevent them from being loaded in a manner that utilizes all of the container's space. In addition, some cargo may be fragile, limiting the weight of the items that can be stacked on top of it.

The manner in which the cargo is loaded can also prevent the efficient use of space. Cargo is generally loaded in one of two configurations. Pallet-loaded cargo is first secured to a pallet and then loaded onto a trailer. Floor-loaded cargo is loaded directly onto the floor of the trailer. Transporting pallet- and floor-loaded cargo in a single trailer can be difficult, as each type of cargo generally fills the trailer to a different height. Pallet-loaded cargo may rise to within about two feet of the ceiling of the trailer, while floor loaded cargo may rise to within a few inches of the trailer ceiling. Accordingly, an airbag having a single size in the depth dimension of the trailer cannot effectively secure both types of cargo. An airbag having a height of a few inches is sufficient to secure the floor-loaded cargo, but will not fill the space above the pallet-loaded cargo. Accordingly, there is a need for a cargo restraint system that can simultaneously restrain cargo of various heights, such as floor- and pallet-loaded cargo.

Some embodiments are described to provide systems and methods for securing cargo in a trailer. Although described in the example of a trailer, the systems and methods are equally applicable for use with a variety of container types and may also be used with airplane or ship cargo holds. The systems and methods provide flexibility for transporting various quantities and types of cargo, and can be efficiently integrated into existing trailers. The systems and methods do not require a priori knowledge of the cargo to be shipped or the layout of the cargo once the trailer has been loaded. In some embodiments, the system is automatically deployed, adaptively conforming to the configuration required to keep the cargo in place.

The system in some embodiments includes an array of airbags that are suspended from the ceiling of the trailer. Each airbag can connect to a support structure that is fixed to the ceiling of the trailer. The support structure may be integrated into the ceiling of the trailer, or may be retrofitted to the trailer. During loading and unloading of the cargo, the airbags are in a deflated configuration, compressed to the ceiling of the trailer. Once the cargo has been loaded, a pressure system inflates the airbags. As the airbags inflate, they extend toward the floor of the trailer. The air pressure system continues to inflate the airbags until the underside of each airbag contacts cargo, or the floor of the trailer. The airbags exert a downward force on the cargo, maintaining the position of the cargo during transport. If sections of the trailer have no cargo, the airbags can form columns that occupy the open sections, preventing cargo in other areas from sliding into the unoccupied sections.

The terms “container” and “trailer” are used interchangeably herein to refer to any structure having a space for holding cargo. Examples of such structures include shipping containers, railway cars, cargo aircraft, moving vans, and tractor trailers.

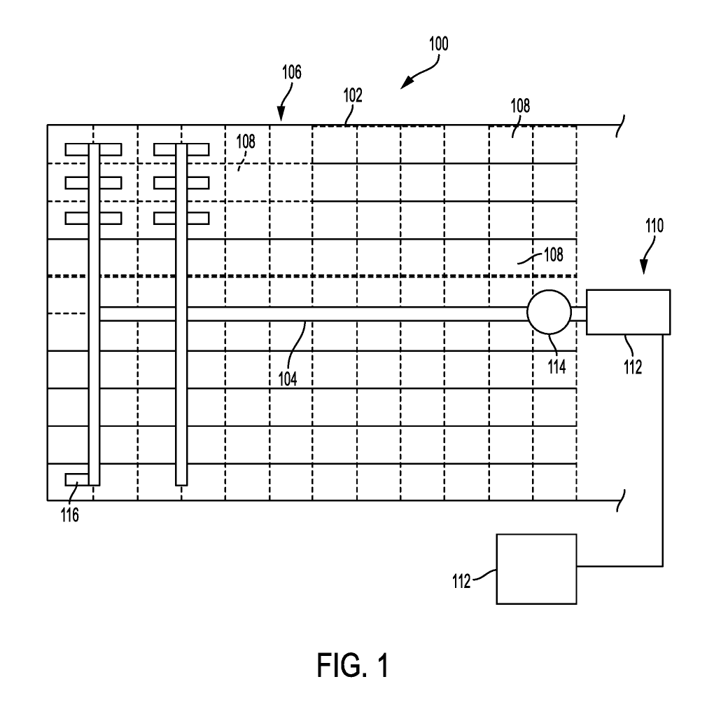

A plan view of an airbag system 100 for securing cargo in a container 102 according to some embodiments is shown in FIG. 1. The airbag system 100 includes a support structure 104 adapted to attach to a ceiling of the container 102. The system 100 includes an array 106 of airbags 108 suspended from the support structure 104. Each airbag 108 may be removeably detachable from the support structure 104. The system 100 may also include an air pressure system 110 in fluid communication with each of the plurality of airbags 108, and a control system 112 adapted to control the air pressure system 110 to inflate the plurality of airbags 108.

According to some embodiments, the air pressure system 110 includes an air compressor 112 and a pressure regulator 114. The air pressure system 110 may also include a pneumatic manifold connecting the air compressor 112 and a pressure regulator 114 to a plurality of electronic pressure control valves 116. The pneumatic manifold may be integrated into the support structure 104, or may comprise a separate structure.

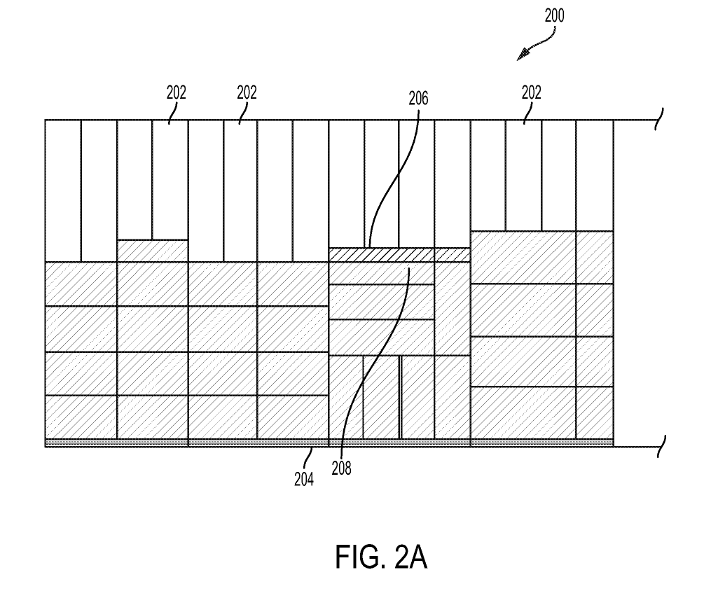

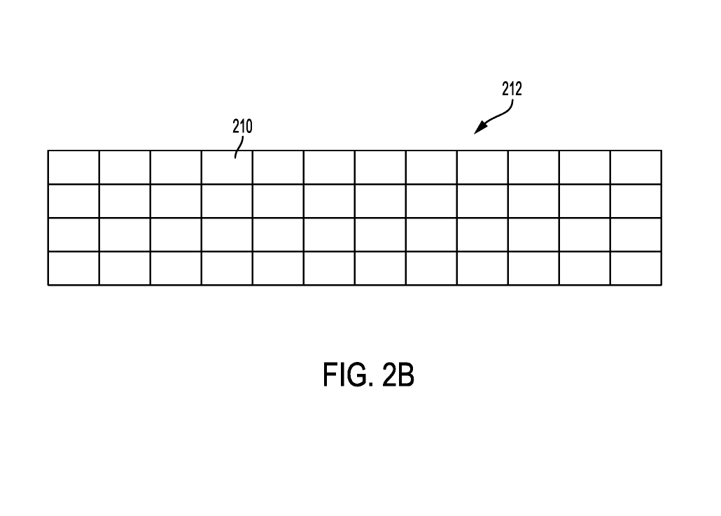

FIG. 2A shows a side view of the airbag system 200 in an inflated configuration. The plurality of airbags 202 extend downward from the support structure toward a floor 204 of the container until each of the plurality of airbags 202 contacts an upper surface 206 of the cargo 208 or the floor 204 of the container.

The support structure can be a frame-like structure that is attached to the ceiling of the container. The support structure may include a plurality of metal or plastic struts that are integrally formed, or are welded or mechanically fixed to one other. The support structure may form a two-dimensional grid. The grid may extend along the length of container. The grid may also extend along the width of the container. The grid may include a primary support extending the length of the container, and plurality of secondary supports branching off from the primary support, as shown in FIG. 1. Alternatively, the support structure may include one or more discrete sections that each cover a portion of the container.

The support structure may have locking mechanisms for securing the airbags to the support structure. The locking mechanisms may have a quick-release feature for quickly removing and replacing an airbag, for example, if the airbag is punctured, or if an airbag having a different size or structure is desired. The support structure may cover a sufficient area of the ceiling of the trailer to support enough airbags to substantially fill the volume of the trailer. The support structure may also provide support for the air pressure system.

An array of airbags is suspended from the support structure. Each airbag of the array of airbags can be easily attached to and detached from the support structure. The airbags in some embodiments are attached to the support structure such that the array of airbags covers the surface area of the ceiling of the container. As described above, FIG. 1 shows a birds-eye view of a container having an airbag system 100. The array 106 of airbags 108 fills the surface area of the ceiling of the container 102. In the example shown in FIG. 1, each airbag 108 is proximal to its neighbors without space disposed between them. Thus, the ceiling of the container is substantially covered by the airbags 108. However, the embodiments of the invention are not limited to this configuration. The airbags 108 may be arrayed with space between them, and may not cover the surface area of the ceiling of the container.

In some embodiments, each of the airbags has the same length and width. In some embodiments, the length is equal to the width. In other embodiments, the airbags may not be uniform. As shown in FIG. 2B, the airbags 210 may not have a uniform size, but the array 212 of airbags 210 may still continuously cover the surface area of the ceiling of the container. In another example, the airbags in one area of the container may have a first set of dimensions, while the airbags in another area of the container may have a second set of dimensions. The airbags can easily be switch in and out of the system using the locking mechanisms of the support structure.

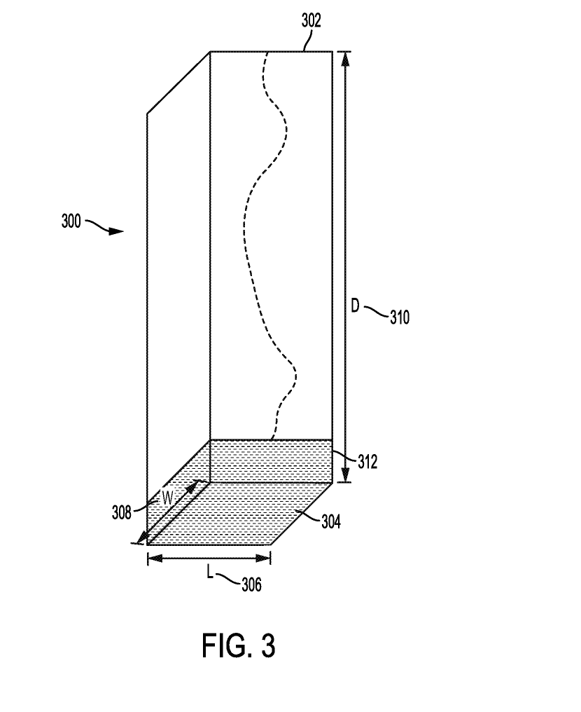

An airbag according to some embodiments is shown in FIG. 3. The airbag 300 has an upper surface 302 that is attached to the support structure, and a lower surface 304 that upon inflation extends downward until it contacts cargo or the floor of the container. The airbag 300 has a length 306 and width 308. The length 306 and width 308 extend in a plane of the ceiling of the container. The length 306 may be equal to the width 308, or may be different from the width 308. In one example, the length 306 and width 308 are each about 1 ft. However, the length and width are not limited to this size, and may be larger or smaller than 1 ft.

Upon inflation, the airbag has a depth 310. The length 306 and width 308 of an airbag in an inflated configuration are generally fixed, while the depth 310 of the airbag will depend on the height of the cargo below it, and therefore may vary from airbag to airbag, and may also be different each time a given airbag is inflated. The depth 310 may be greater than or less than the length 306 and width 308.

The term “depth” is used herein to describe the distance between the upper and lower surfaces of an airbag. The position of the upper surface of the airbags can be fixed, and is adjacent to the support structure fixed to the ceiling of the container. The position of the lower surface, however, can depend on the cargo in the trailer. If cargo is disposed below an airbag, the lower surface of the airbag will extend downward until it contacts the upper surface of the cargo. If no cargo is disposed below the airbag, the airbag may extend downward until it contacts the floor of the container. Thus, the depth dimension of each airbag can be varied. Correspondingly, the volume of each airbag in the inflated configuration can also be varied.

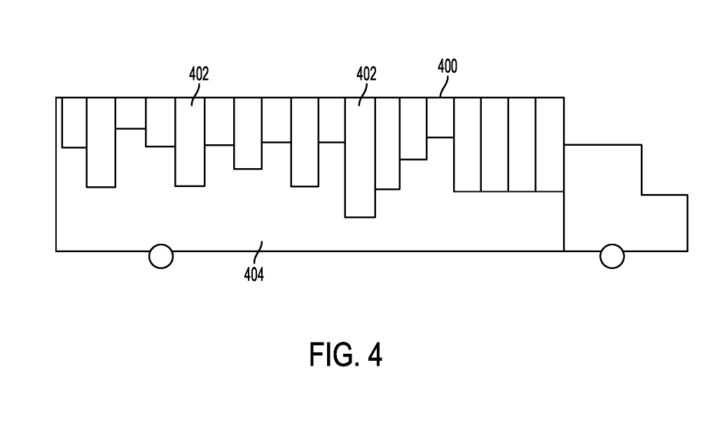

Further, because each airbag is fixed to the support structure but not connected to the rest of the airbags in any other way, each airbag can have a depth that is independent of the depth of neighboring airbags. This concept is illustrated in FIG. 4, which shows a container 400 having an array of air bags 402 in an inflated configuration. Each airbag 402 extends to a different depth. This configuration allows the airbag system to adapt to the shape of the cargo 404. While FIG. 4 shows the depth of the airbags varying along the length of the trailer, the depth of the airbags in the width-dimension of the trailer may also vary from airbag to airbag.

The airbags in some configurations have a cuboid shape, as shown in FIG. 3. The airbags form rectangular columns that extend downward to fill the unoccupied volume of the container once the cargo has been loaded. The airbags effectively reduce the size of the container until the cargo is surrounded on all sides. This prevents the cargo from shifting, sliding, or toppling.

As described above, securing pallet- and floor-loaded cargo in a single trailer can be challenging. The different types of cargo can rise to different heights, requiring different sizes of restraining pillows. The system described herein addresses that challenge by adaptively lowering to the appropriate depth for the type of cargo.

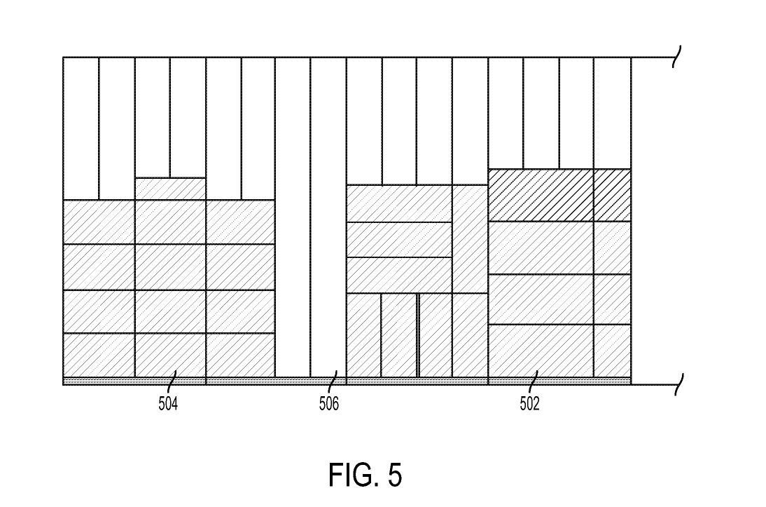

Further, pallet-loaded cargo is often loaded with a pillow between adjacent pallets, while floor-loaded cargo is continuously loaded and then a pillow is placed between the rear-most cargo and the door of the trailer. The system described herein can provide both configurations, and can also combine the configurations. For example, FIG. 5 shows two groups of cargo 502, 504 separated by air bags 506 that extend all the way down to the floor of the container. This configuration can be used for separating individual pallets, for separating floor- and pallet-loaded cargo, or for separating cargo going to different destinations, for example.

While the container is being loaded and unloaded, the airbags may be stored in a deflated configuration adjacent to the ceiling of the container. The airbags may automatically rise to the height of the support structure when they are deflated. A retracting mechanism may also be used to retract the deflated airbags, so that they do not hang down while the container is being loaded and unloaded. The retracting mechanism may include one or more rollers. The lower surface of each air bag may be connected to a roller such that when the roller is rotated, either manually or electronically, the lower surface of the airbag is retracted until it reaches the approximate height of the support structure. Other mechanisms may also be used to retract or restrain the airbags in the deflated configuration.

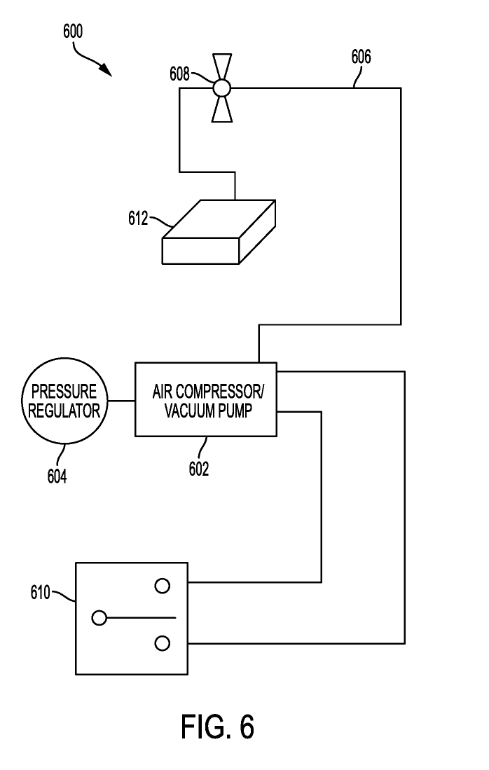

Once the cargo has been loaded, a pneumatic system can be used to fill each of the airbags. An example pneumatic system is shown in FIG. 6. The pneumatic system 600 may include a compressor 602, a pressure regulator 604, a pneumatic manifold 606, and a plurality of pressure valves 608. A control system 610 may control the compressor 602 and pressure valves 608 to fill the airbags. For example, once the cargo has been loaded, the control system 610 may turn on the compressor 602 and open the pressure valve 608 to each airbag to be inflated. The compressor 602 injects air into the pneumatic manifold 606, which directs air to the airbag pressure valves 608. The pressure regulator 604 may regulate the pressure introduced by the compressor 602 into the pneumatic manifold 606. The pneumatic manifold 606 and pressure valves 608 may be independent of the support structure attached to the ceiling of the container, or may be integrated into the support structure. The compressor 602 may be an air compressor or a vacuum pump, for example.

In some embodiments, each airbag has its own pressure valve 608 that can be opened or closed. The pressure valves 608 may be electronic pressure control valves. During loading and unloading, the pressure valve 608 may be closed to maintain the airbag in a deflated state. Once the cargo has been loaded, the pressure valve 608 may be opened, introducing air into the airbag. The control system 610 controls the compressor 602 to continue operating until each airbag has reached a desired pressure. In some configurations, each airbag has an individual pressure sensor 612 that senses the air pressure of the inflated airbag. The pressure sensor 612 may be adapted to send an indication of the sensed air pressure to the control system 610. The control system 610 can use the indication of the sensed pressure to determine when the airbag has reached an appropriate pressure, and then can close the pressure valve 608 for that airbag.

Alternatively, the pneumatic system may have a single pressure sensor that senses the pressure of the manifold and airbags. For example, the control system may open all of the airbag pressure valves, and may keep them all open until the pneumatic system as a whole has reached a desired pressure. Each bag may inflate until its lower surface contacts the upper surface of cargo or the floor of the container. The control system regulates the pressure of the system such that once an airbag expands to a maximum depth (determined by the cargo below it), air is no longer injected into that airbag, but continues to fill other airbags that have not yet been maximally inflated. The control system controls the compressor to continue injecting air into the system until the system reaches a predetermined pressure, indicating that each of the airbags has attained an appropriate depth to secure the cargo below it. At that point, the control system may close all of the pressure valves and stop the compressor. The system may also operate to maintain the desired pressure in the air bag(s) or the application of a desired force.

The control system may use the pressure sensor for each airbag to determine whether that airbag has been maximally inflated. The maximal inflation for each airbag is determined by the cargo positioned below the airbag. If cargo is stacked to the ceiling of the container, the airbag or airbags above the cargo may become maximally inflated when only a small amount of air is introduced. If the cargo is stacked so high that it presses against the airbags above it, the airbags may not require any inflation. These airbags may be considered maximally inflated if they exert sufficient force on the cargo below them to prevent the cargo from sliding or moving.

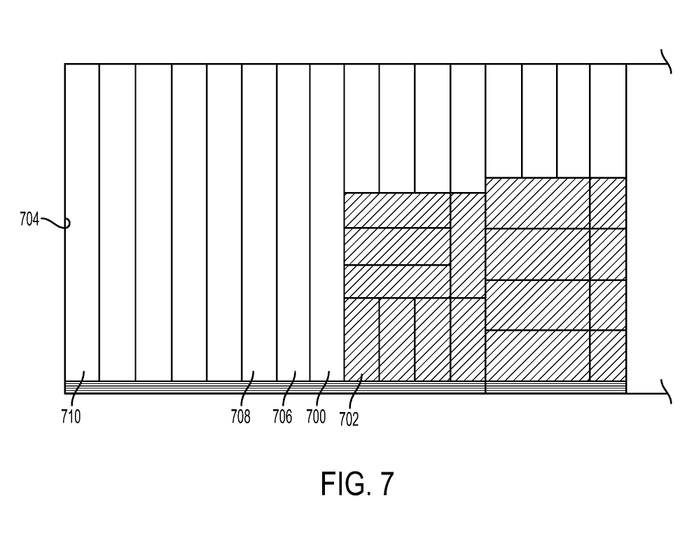

Alternatively, for airbags without cargo underneath them, maximal inflation may correspond to sufficient inflation to expand the airbag down to the floor of the container. The airbags provide a columnar barrier that prevents cargo in other sections from sliding into a section that would otherwise be empty. For example, if only the front half of a trailer is loaded with cargo, the airbags in the rear half of the trailer can be maximally inflated to have a configuration that extends to the floor of the trailer. This scenario is shown in FIG. 7. The airbags nearest the cargo 702 prevent the cargo 702 from sliding toward the rear 704 of the trailer. The airbags 700 nearest the cargo 702 are supported by the adjacent airbags 706 disposed farther toward the rear 704 of the trailer. Those airbags 706 are supported by their neighbors 708, and the support structure continues until the final row of airbags 710, which are horizontally supported by the trailer door at the rear 704 of the trailer. Thus, each airbag in the array provides support for the airbags around it, enabling a structure that can maintain the position of the cargo in the container, independent of how the cargo is distributed, or the height to which the container is filled. Further, as described above, floor-loaded cargo is generally continuously loaded to the back of the trailer, and then a pillow is placed between the cargo and the rear door of the trailer. The system described herein can easily provide the necessary support for this situation.

In a maximally inflated state, the airbags will exert a downward force on the cargo below them, or on the floor of the container. The magnitude of the force will depend on the air pressure in each of the airbags. If an airbag is inflated to a higher air pressure, the lower surface of the airbag will exert a larger downward force than if the airbag were inflated to a lower pressure. Each of the airbags in the array may be filled to the same air pressure. Alternatively, the control system may use the pressure valve for each airbag to inflate each airbag to a particular air pressure that may not be the same as the air pressure of other airbags.

The air pressure for a single airbag or the array of airbags may be determined by a variety of factors. Such factors can include the structural characteristics of the cargo, as well as the temperature inside the container, for example. If the cargo being transported is very delicate, a large downward force applied by the airbags on the cargo could damage the cargo. If the cargo is very heavy, a large downward force may be necessary in order to prevent the cargo from sliding, and therefore the airbags may be inflated to a high air pressure. Higher air pressure will also provide greater columnar strength for the airbags. For example, if cargo were to tilt toward an adjacent airbag, an airbag inflated to a higher air pressure would provide a greater lateral force on the cargo, preventing it from toppling.

The air pressure in the airbags may change if the temperature in the container changes. For example, if the container is loaded in an air-conditioned warehouse and then is driven for hours in a hot climate, the air pressure in the airbags will increase as the temperature of the container increases. Taking this into account, the airbags may be initially filled to an air pressure that is lower than the desired pressure for transportation, with the expectation that the container will become warmer, and the pressure in the airbags will increase. Alternatively, the airbags may include pressure sensors that periodically or continuously monitor the pressure in each airbag. If the pressure in a particular bag drops below a predetermined value, the control system may open the pressure valve for that airbag and further inflate the airbag. If the pressure in a particular airbag exceeds a predetermined value, the control system may open the pressure valve for that airbag and release some of the air. However, an increase or decrease in the air pressure in an airbag may indicate that the cargo has shifted. The control system may be adapted to communicate with an operator of the vehicle to indicate that the cargo may have shifted, and may require attention.

The control system can be a dedicated “hard-wired” device, or it can be a programmable device. For example, it can be, but is not limited to, a personal computer, a tablet, a personal digital assistant (PDA), a work station, or any other suitable electronic device for the particular application. The control system may have a user interface. The user interface may include a screen for displaying information. The screen may also be adapted to receive information, like a touch screen. The user interface may also include buttons or a keyboard for receiving user input.

The air pressure in the airbags may be set by a user. For example, the control system may have user interface that allows a user to select an air pressure for the array of airbags as a whole, for a section of airbags, or for each individual airbag. Alternatively or additionally, the air pressure in the airbags may be controlled based on the force that the lower surface of the airbag applies on the surface below it. The airbag may be equipped with a force sensor on its lower surface. An example of this configuration is shown in FIG. 3, where the airbag 300 has a force sensor 312 disposed at its lower surface 304. The force sensor 312 may sense the force applied on the airbag 300 by the surface below it. The control system may monitor the applied force sensed by the force sensor 312, and may close the airbag's pressure valve when the force has reached a desired value. Thus, the force sensor 312 may replace the pressure sensor 612 in FIG. 6, or may be used in addition to the pressure sensor 612.

The desired value of the force may be selected based on a variety of factors, including but not limited to characteristics of the cargo being transported. For light-weight or fragile cargo, the force may be smaller, while for heavy or robust cargo, the force may be greater. However, other factors may also be taken into account for selecting the desired force. The control system may be pre-programmed to attain a particular force, or a user may select a desired force, for example, using a user interface in communication with the control system.

The control system may be automatically configured to inflate and deflate the airbags. For example, the airbag system may include one or more door sensors that indicate to the control system whether the doors of the trailer are open or closed. For example, when the door has been closed, the door sensor may send a first signal to the control system, and when the door has been opened, the door sensor may send a second signal to the control system. The control system may automatically inflate the airbags when it receives the first signal, and may automatically deflate the airbags when it receives the second signal. The control system may also have a switch for turning on and off the automatic inflation and deflation mode. The control system may be an electronic control unit (ECU). The airbag system may also be controlled manually, with a switch for inflating or deflating the airbags.

The system may be adapted to inflate or deflate subsections of the array of airbags. For example, once a first section of the container is loaded with cargo, it may be desirable to inflate the airbags above and even adjacent to that section prior to loading the rest of the container. The airbags may protect the cargo in the first section from being jostled or damaged while the rest of the container is loaded with cargo. Alternatively, if all of the cargo in the container is not intended for the same destination, the airbags in one section of the container can be deflated to allow cargo in that section to be unloaded, while the airbags in other sections can remain inflated to protect the cargo that will remain in the container.

A container for shipping cargo may include the airbag system described herein. For example the container may include a support structure attached to a ceiling of the container, and an array of airbags suspended from the support structure, each airbag being removeably detachable from the support structure. The container may also include an air pressure system in fluid communication with each airbag of the array of airbags, and a control system adapted to control the air pressure system to inflate the array of airbags. In an inflated configuration, the array of airbags extends downward from the support structure toward a floor of the container until each airbag of the array of airbags contacts an upper surface of the cargo or a floor of the container.

A method for securing cargo in a container includes securing an array of airbags to the ceiling of the container. The airbags may be secured to a pre-existing support structure in the container, or the container may be retrofitted with a support structure. The airbags may be attached to the support structure in a manner that allows them to be quickly released from the support structure, for example, for maintenance of the airbags.

After the container is loaded with cargo, the array of airbags is inflated such that each airbag extends downward from the ceiling of the container and exerts a downward force on either the cargo or the floor of the container. The airbags do not have to extend down to the same depth. Each airbag can extend to a depth that is different than that of the rest of the airbags in the array.

Once the airbags are inflated to a desired pressure or they exert a desired force on the surface below them, the inflating ceases. The air pressure may be maintained as the cargo is transported. Once the container arrives at the cargo's destination, the airbags are deflated, and the cargo can be unloaded.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. An airbag system for securing cargo in a container, comprising:
a support structure adapted to attach to a ceiling of the container;
an array of airbags suspended from the support structure, each airbag being removeably detachable from the support structure;
an air pressure system in fluid communication with each air bag of the array of airbags; and
a control system adapted to control the air pressure system to inflate the array of airbags,
wherein, in an inflated configuration, the array of airbags extends downward from the support structure toward a floor of the container until each airbag of the array of airbags contacts an upper surface of the cargo or the floor of the container.

2. The airbag system for securing cargo in a container according to claim 1, wherein each air bag of the array of airbags is adapted to extend downward to a depth that is independent of the depth to which other of the array of airbags extends.

3. The airbag system for securing cargo in a container according to claim 1 or 2, wherein in the inflated configuration, a size of each airbag is fixed in two dimensions and is variable in a third dimension,
wherein the third dimension extends from the ceiling of the container to the floor of the container.

4. The airbag system for securing cargo in a container according to one of claims 1-3, where each airbag in the inflated configuration has a shape of a rectangular cuboid.

5. The airbag system for securing cargo in a container according to one of claims 1-4, wherein each bag has a length and a width extending in a plane of the ceiling of the container, and a depth extending in a direction from a ceiling of the container to the floor of the container, and
wherein in the inflated configuration the depth of at least one airbag is greater than the length and the width of the at least one airbag.

6. The airbag system for securing cargo in a container according to one of claims 1-5, wherein the array of airbags substantially covers the ceiling of the container, and
wherein each of the airbags of the array of airbags may be inflated to have a different volume than each of the other airbags of the array of airbags.

7. The airbag system for securing cargo in a container according to one of claims 1-6, wherein the support structure comprises struts forming a two-dimensional grid.

8. The airbag system for securing cargo in a container according to one of claims 1-7, wherein the air pressure system comprises:
an air compressor; and
a manifold in fluid communication with the air compressor,
wherein the control system is adapted to control the air compressor to inject air into the manifold.

9. The airbag system for securing cargo in a container according to claim 8, wherein the manifold is integrated into the support structure.

10. The airbag system for securing cargo in a container according to one of claims 8 and 9, wherein the air pressure system comprises a plurality of fluid pressure valves, each valve in fluid connection with the manifold and one airbag of the array of airbags,
wherein the control system is adapted to open and close each of the plurality of fluid pressure valves to inflate each airbag of the array of airbags.

11. The airbag system for securing cargo in a container according to one of claims 1-10, wherein the air pressure system comprises a plurality of pressure sensors, each pressure sensor adapted to sense an air pressure of one of the airbags of the array of airbags.

12. The airbag system for securing cargo in a container according to claim 11, wherein the control system is adapted to receive an indication of the air pressure of an airbag of the array of airbags from a pressure sensor corresponding to the airbag, and adjust an air pressure of the airbag based on the indication.

13. The airbag system for securing cargo in a container according to one of claims 1-12, further comprising a force sensor disposed on a lower surface of an airbag of the array of airbags, the force sensor being in communication with the control system,
wherein the control system is adapted to adjust an air pressure of the airbag based on a force applied on the lower surface of the bag sensed by the force sensor.

14. The airbag system for securing cargo in a container according to one of claims 1-13, further comprising:
a door sensor adapted to sense whether a door of the container has been opened or closed,
wherein, when the door has been closed, the door sensor sends a first signal to the control system.

15. The airbag system for securing cargo in a container according to claim 14, wherein the control system is adapted to automatically inflate the airbags when the control system receives the first signal from the door sensor.

16. The airbag system for securing cargo in a container according to one of claims 14 and 15, wherein when the door has been opened, the door sensor sends a second signal to the control system,
wherein the control system is adapted to automatically deflate the airbags when the control system receives the second signal from the door sensor,
wherein the airbags in a deflated configuration are retracted toward the ceiling of the container.

17. A container for shipping cargo, the container comprising:
a support structure attached to a ceiling of the container;
an array of airbags suspended from the support structure, each airbag being removeably detachable from the support structure;
an air pressure system in fluid communication with each airbag of the array of airbags; and
a control system adapted to control the air pressure system to inflate the array of airbags,
wherein, in an inflated configuration, the array of airbags extends downward from the support structure toward a floor of the container until each airbag of the array of airbags contacts an upper surface of the cargo or a floor of the container,
wherein the array of airbags contacts the upper surface of the pallet-loaded freight and the floor-loaded freight at a plurality of different heights, and
wherein the array of airbags provides downward forces on the pallet-loaded freight and the floor-loaded freight that prevent the pallet-loaded freight and floor-loaded freight from becoming dislodged during transport of the cargo.

18. A method for securing cargo in a container, the method comprising:
securing an array of airbags to a ceiling of the container; and
after the container has been loaded with cargo, inflating the array of airbags such that each airbag extends downward from the ceiling of the container and exerts a downward force on either the cargo or a floor of the container.

19. The method for securing cargo in a container according to claim 18, the method further comprising:
after the loaded container has been transported to a destination for the cargo, deflating the array of airbags and retracting each airbag toward the ceiling of the container.
